(19) United States
(12) Patent Application Publication
(10) Pub. No.: US 2025/0217433 A1
(43) Pub. Date: Jul. 3, 2025

(54) INTELLIGENT QUBO CUTTING ORCHESTRATOR

(71) Applicant: Dell Products L.P., Round Rock, TX (US)

(72) Inventors: Diego Vrague Noble, Pelotas (BR); Ítalo Gomes Santana, Rio de Janeiro (BR); Miguel Paredes Quiñones, Campinas (BR)

(21) Appl. No.: 18/401,143

(22) Filed: Dec. 29, 2023

(51) Int. Cl. G06F 17/11

(52) U.S. Cl. CPC G06F 17/11; G06N 10/60

(57) ABSTRACT

Systems and methods for cutting QUBOS and/or executing QUBOs is disclosed. A QUBO is cut into subQUBOs. For a first iteration, a trained classifier identifies an annealing system. The updated subQUBOs are analyzed to determine whether the next iteration can be performed in a simulated annealing system. Otherwise, the classifier is invoked using the updated subQUBO to identify the annealer for the next iteration. The simulated annealer is selected when possible and without using the classifier. The process stops after a minimum is achieved or after a specified number of iterations.

### FIELD OF THE INVENTION

Embodiments of the present invention generally relate to quantum computing systems and quantum computing related operations. More particularly, at least some embodiments of the invention relate to systems, hardware, software, computer-readable media, and methods for performing a cutting operation to decompose a problem into subproblems and for selecting a quantum computing system.

### BACKGROUND

Quantum computing systems, which include both physical quantum annealers, simulated quantum annealers, and simulated annealers, are often used to generate solutions to difficult problems such as combinatorial problems. Due to the processing and time required to prepare a combinatorial problem for execution in a quantum computing system and execute the combinatorial problem in the quantum computing system, attempts have been made to reduce the resource and time requirements.

In one example, a problem may be cut into subproblems. In the context of quadratic unconstrained binary optimization (QUBO) problems, a cutting operation may split or decompose a QUBO into smaller QUBO problems (referred to herein as subQUBO problems). A cutting operation, in other words, is an attempt to simplify or decompose a problem into more manageable smaller problems.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of an orchestration engine or system configured to perform operations including cutting and selection operations;

FIG. 2 discloses aspects of training a classifier to predict a quantum computing system for executing a QUBO problem;

FIG. 3 discloses aspects of a method for a cutting and/or annealer selection operation; and

FIG. 4 discloses aspects of a computing device, system, or entity.

### DETAILED DESCRIPTION OF SOME EXAMPLE EMBODIMENTS

Embodiments of the present invention generally relate to quantum computing systems and quantum computing related operations. More particularly, at least some embodiments of the invention relate to systems, hardware, software, computer-readable media, and methods for orchestrating a cutting operation and/or the execution or iterations of subproblems generated by a cutting operation.

Embodiments of the invention are discussed in the context of quadratic unconstrained binary optimization (QUBO) models, but may be applied to other models such as Ising models. Embodiments of the invention are also discussed in the context of quantum computing systems, such as quantum annealers. Embodiments of the invention operate in the context of quantum computing systems including, but not limited to, physical quantum annealers, simulated quantum annealers and simulated annealers. By way of example and not limitation, simulated annealers and simulated quantum annealers may operate in classical computing systems. A simulated annealer, however, may use bits to represent solutions while a simulated quantum annealer may use qubits to represent solutions.

A QUBO cutting operation is a technique that enables large QUBO problems to be solved by quantum computing systems. For example, a quantum computing system may not have enough qubits for a given problem or may be inefficient for other reasons. The cutting operation splits or decomposes an original QUBO problem into subQUBOs. The subQUBOs resulting from the cutting operation are more easily solved using available annealers. Stated differently, quantum annealing systems may have difficulty accommodating the qubit requirements of large QUBO problems. Cutting the QUBO into subQUBOs facilitates the execution of the smaller subQUBOs in available annealers. Embodiments of the invention also select specific annealers for executing the subQUBOs. Embodiments of the invention, for each execution iteration, may select a different annealer.

Embodiments of the invention relate to orchestrating the execution of subQUBOs generated from or during a cutting operation. In one example, the cost of executing a QUBO in a simulated annealer may be less than executing the QUBO in a physical quantum annealer or a simulated quantum annealer. Embodiments of the invention further relate to selecting an annealer for performing quantum computing related operations. Embodiments of the invention may also select an annealer based on cost, execution time, or the like or combination thereof.

A cutting operation is more complicated than simply dividing an original QUBO into smaller pieces at least because the subQUBOs are often updated or changed. Embodiments of the invention relate to cutting operations that account for the manner in which the subQUBOs are updated. When executing the subQUBOs resulting from the cutting operation, the subQUBOs may be executed in an iterative manner. The subQUBOs are updated after each iteration and embodiments of the invention relate to identifying and selecting the appropriate annealer for each execution or each annealing iteration. Embodiments of the invention also adapt to the fact that an original QUBO may be cut in different manners based on available resources or quantum annealing systems.

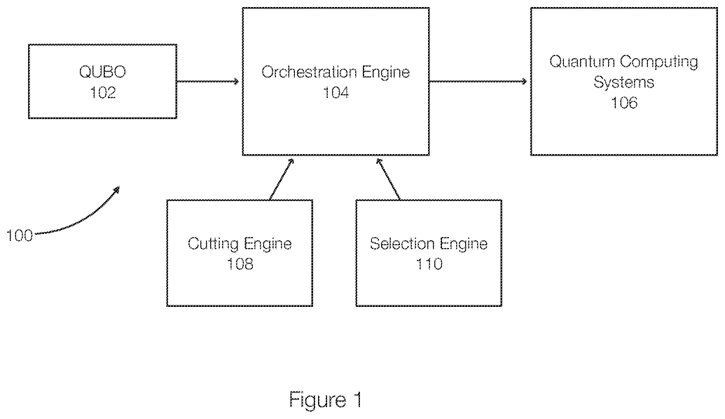

FIG. 1 discloses aspects of an orchestration system configured to orchestrate the execution of problems including optimization problems. In FIG. 1, a QUBO 102 (or other representation of a problem) is received by an orchestration engine 104. The orchestration engine 104 may perform some processing on the QUBO 102 if received in a different format or form. The orchestration engine 104 may be a cloud-based service and may include processors, memory, networking hardware, and the like.

The orchestration engine 104 may perform or orchestrate the performance of various operations including, but not limited to, converting the QUBO 102 into a graph, performing minor embedding operations, initialization operations, encoding operations, qubit mapping operations, quantum computing system selection operations, or the like.

Generally, the orchestration engine 104 receives the QUBO 102, performs various processing operations, selects a specific quantum computing system from among the quantum computing systems 106, sends the QUBO 102 to the selected quantum computing system, and returns a solution to the QUBO 102 to a client.

Some of the operations performed by the orchestration engine 104 may include a cutting operation and a selection operation. In one example, the selection operation may be performed as part of the overall cutting operation. The cutting operation may be performed by a cutting engine 108 and the selection operation may be performed by a selection engine 110. In one example, the selection engine 110 is a part cutting engine 108.

To perform a QUBO cutting operation, the problem of separating the original QUBO into k groups with a minimum number of (i) monomials, and (ii) non-zero coefficients among these groups is considered. The output of the cutting operations may include a portioned matrix, for each individual subQUBO such as:

$$Q = ( \begin{matrix}{Q}_{1 , 1} & … & {Q}_{1 , N} \\ ⋮ & ⋱ & ⋮ \\ {Q}_{N , 1} & … & {Q}_{N , N}\end{matrix} ) .$$

These individual QUBOs may be run or executed on different types of annealers (or other quantum computing systems). Every iteration may run K number of QUBO problems (the number of subQUBOs). One set of values xₖⁱ at iteration l generates a solution for problem p_{k,l}. Thus every k QUBO problem p_{k,l} at iteration l is:

$${P}_{k , l} : {min}_{{x}_{k}} {x}_{k}^{T} {Q}_{k , k} {x}_{k} + {\sum }_{j ∈ \{ 1 … K \} \backslash k} {x}_{k}^{T} {\hat{Q}}_{kj} {x}_{j}^{l - 1} .$$

In this example, Q_{k,k} is the part of the QUBO matrix that only interacts variables on subset k, and Q_{k,j} is the part of the QUBO matrix where variables of subset k and j interact. This heuristic permits a current solution x^{l} to be saved. The iteration process may be stopped one a local minimum is achieved or found or after performing a number of L iterations.

Another advantage of partitioning an original problem (e.g., QUBO) into smaller problems (e.g., subQUBOs) is to facilitate analysis of their heterogeneous structures to solve each of them in a more adequate hardware (e.g., CPU (central processing unit), Quantum Annealer, FPGA (field programmable gate array)), or even a specific algorithm or heuristic that uses the same hardware with other algorithms, such as simulated annealing and simulated quantum annealing. The selection engine, in one example, may perform aspects of the orchestration required to deliver each subQUBO to the appropriate system or annealer.

QUBO are known as hard to be solved by simulated quantum annealing systems when the eigenvalues of the QUBO matrix are indefinite and eigenvalues are near in size because this creates a very irregular landscape on the energy function. In this example, a physical quantum annealing system may provide better performance.

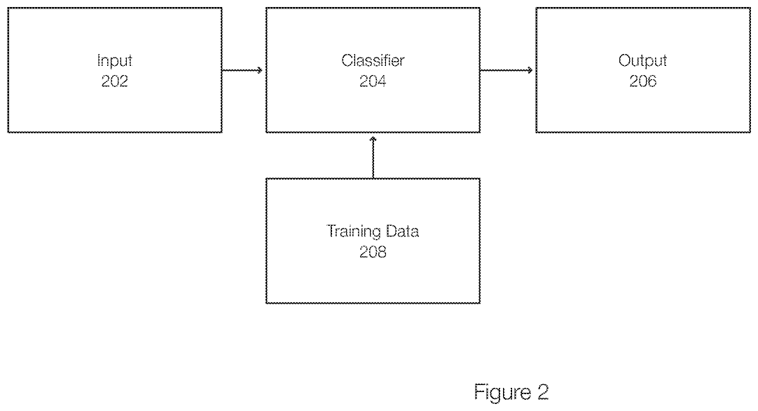

FIG. 2 discloses aspects of training a classifier that is configured to identify a quantum annealing system for executing a QUBO. A classifier 204 is trained using training data 208. The training data 208 includes historical information relates QUBO problems, data describing or about the quantum computing systems (both physical and simulated) such as execution times, number of qubits, and the like.

Once the classifier 204 is trained, the classifier 204 may be used to generate inferences, predictions, or classifications. For example, an input 202 is input to the classifier 204. The input 202 may include a subQUBO and/or metadata related to or describing the subQUBO. The output 206 may be a specific quantum computing system. Thus, the learned classes of the classifier 204 may each represent or correspond to an annealing system and the classifier 204 classifies the input 202 to identify the recommended annealing system for executing the input 202.

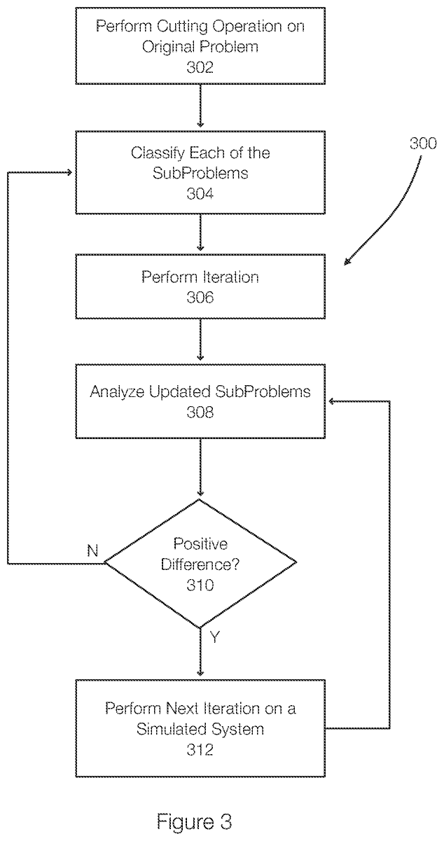

FIG. 3 discloses aspects of orchestrating the execution of an original problem, which may be represented or presented as a QUBO. The method 300 includes aspects related to cutting and/or selecting a quantum computing system or an annealing system, which may be performed as part of a cutting operation in one example. Aspects of the method 300 may be performed independently in some examples. For example, training the classifier may be performed separately and/or independently from the method 300.

The method 300 initially include performing 302 a cutting operation on an original problem or original QUBO. Cutting an original QUBO generates a set of subQUBOs. For example, an original QUBO problem P may be cut into smaller QUBOS as follows: {p₁, p₂, . . . , pₖ}⊂P.

Next, each of the subQUBOs {p₁, p₂, . . . , pₖ} are classified 304 using the previously trained classifier. Next, an iteration is performed 306 in the quantum computing systems recommended by the classifier (e.g., a quantum computing system is recommended for each of the subQUBOs. More specifically, the classifier is used in an example embodiment when the first iteration is being performed or l=1 for each subQUBO problem Qₖ according to its structure.

After the first iteration has been performed in the quantum computing systems recommended by the classifier, the subQUBOs are updated accordingly. Next, the updated subQUBOs are analyzed 308.

More specifically, the QUBO composition after an iteration may be represented as follows: S^{l}=ΣΣ_{j∈{1 . . . K}\k}xₖ^{T}\hat{Q}ₖⱼxⱼ^{l-1}=x^{T}sₖ^{l}.

In one example, analyzing 308 the updated subQUBOs, during/after an iteration, may include determining a difference between a maximum element on the vector sₖ^{l} and a minimum value on the diagonal of Qₖ. If this difference is positive (Y at 310), then the next iteration can be performed 312 in a simulated annealer (classical computing system) without having to run the classifier to identify an appropriate annealing system. If the difference is not positive (N at 310), then the updated QUBO is input to the classifier to obtain a recommended annealer.

The method 300 may be performed for each of the subQUBOs individually once the original QUBO has been decomposed into subQUBOs. The method 300 may end if the subQUBOs are minimized in the quantum annealers or after L iterations. The results of the subQUBOs can be combined to determine a result or solution to the original QUBO.

Embodiments of the invention thus train a machine learning model, such as a classifier, to recommend a suitable quantum annealer for run a subQUBO problem at an initial iteration of a cutting operation or of a selection operation after the QUBO is cut into pieces. In certain circumstances or in subsequent iterations, the classifier may not be needed and a simulated annealer, which is executed in classical computing systems (e.g., processor, memory) is used based on the relationships in in the subQUBO. This can conserve costs associated with orchestrating the processing and execution of optimization problems.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, gated quantum computing operations, quantum annealing operations, compression operations, quantization operations, decompression operations, table construction operations, translation operations, or the like or combination thereof. More generally, the scope of the invention embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, and the like, may take the form of software, physical machines, containers, or virtual machines (VM), though no particular component implementation is required for any embodiment.

Example embodiments of the invention are applicable to any system capable of storing and handling various types of objects, in analog, digital, or other form.

It is noted that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: performing a cutting operation on an original problem to generate subproblems, for each subproblem: classifying the subproblem with a classifier to identify an annealer for performing an initial iteration of the subproblem using the annealer, performing the initial iteration in the annealer identified by the classifier for the subproblem and generating an updated subproblem, comparing a vector of binary variables of the updated subproblem with a diagonal of a QUBO matrix of the updated subproblem, and performing a next iteration when the comparison is positive in a simulated annealer.

Embodiment 2. The method of embodiment 1, wherein the original problem comprises a QUBO and the subproblems comprise subQUBOs that are each smaller than the QUBO.

Embodiment 3. The method of embodiment 1 and/or 2, further comprising training the classifier to predict or classify, for a subQUBO, a recommended annealer.

Embodiment 4. The method of embodiment 1, 2, and/or 3, wherein the annealer is one of a simulated annealer, a simulated quantum annealer, and a physical quantum annealer.

Embodiment 5. The method of embodiment 1, 2, 3, and/or 4, further comprising performing an iteration of the subQUBO with the recommended annealer to obtain an updated subQUBO.

Embodiment 6. The method of embodiment 1, 2, 3, 4, and/or 5, further comprising determining a difference between a maximum element in the vector with a minimum value on a diagonal of the subQUBO matrix.

Embodiment 7. The method of embodiment 1, 2, 3, 4, 5, and/or 6, further comprising inputting the updated subQUBO to the classifier when the difference is not positive.

Embodiment 8. The method of embodiment 1, 2, 3, 4, 5, 6, and/or 7, further comprising performing another iteration with the simulated annealer when the difference is positive or performing another iteration with a new recommended annealer output by the classifier.

Embodiment 9. The method of embodiment 1, 2, 3, 4, 5, 6, 7, and/or 8, further comprising performing a predetermined number of iterations based on the comparison or until the subQUBO is minimized.

Embodiment 10. The method of embodiment 1, 2, 3, 4, 5, 6, 7, 8, and/or 9, wherein a QUBO composition after an l^{th} iteration is represented by S^{l}=ΣΣ_{j∈{1 . . . K}\k}xₖ^{T}\hat{Q}ₖⱼxⱼ^{l-1}=x^{T}sₖ^{l}, and wherein the comparison includes a difference between a maximum element on a vector sₖ^{l} and a minimum value on the diagonal of Q_{k,k}.

Embodiment 11 A system, comprising hardware and/or software, operable to perform any of the operations, methods, or processes, or any portion of any of these, disclosed herein.

Embodiment 12 A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, agent, service, or the like may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

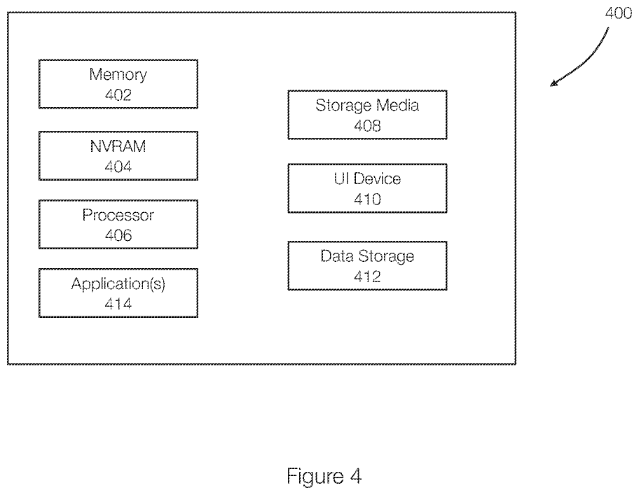

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 400 may represent a server, a service, or the like. For example, the orchestration engine, the cutting engine, and/or the selection engine may be implemented as a computing system that is cloud-based or on-premise based. Client device may submit QUBOs to the orchestration engine.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
performing a cutting operation on an original problem to generate subproblems;
for each subproblem:
classifying the subproblem with a classifier to identify an annealer for performing an initial iteration of the subproblem using the annealer;
performing the initial iteration in the annealer identified by the classifier for the subproblem and generating an updated subproblem;
comparing a vector of binary variables of the updated subproblem with a diagonal of a QUBO matrix of the updated subproblem; and
performing a next iteration when the comparison is positive in a simulated annealer.

2. The method of claim 1, wherein the original problem comprises a QUBO and the subproblems comprise subQUBOs that are each smaller than the QUBO.

3. The method of claim 2, further comprising training the classifier to predict or classify, for a subQUBO, a recommended annealer.

4. The method of claim 3, wherein the annealer is one of a simulated annealer, a simulated quantum annealer, and a physical quantum annealer.

5. The method of claim 4, further comprising performing an iteration of the subQUBO with the recommended annealer to obtain an updated subQUBO.

6. The method of claim 5, further comprising determining a difference between a maximum element in the vector with a minimum value on a diagonal of the subQUBO matrix.

7. The method of claim 6, further comprising inputting the updated subQUBO to the classifier when the difference is not positive.

8. The method of claim 7, further comprising performing another iteration with the simulated annealer when the difference is positive or performing another iteration with a new recommended annealer output by the classifier.

9. The method of claim 1, further comprising performing a predetermined number of iterations based on the comparison or until the subQUBO is minimized.

10. The method of claim 1, wherein a QUBO composition after an l^{th} iteration is represented by S^{l}=ΣΣ_{j∈{1 . . . K}\k}xₖ^{T}\hat{Q}ₖⱼxⱼ^{l-1}=x^{T}sₖ^{l}, and wherein the comparison includes a difference between a maximum element on a vector sₖ^{l} and a minimum value on the diagonal of Q_{k,k}.

11. A non-transitory storage medium having stored therein instructions that are executable by one or more hardware processors to perform operations comprising:
performing a cutting operation on an original problem to generate subproblems;
for each subproblem:
classifying the subproblem with a classifier to identify an annealer for performing an initial iteration of the subproblem using the annealer;
performing the initial iteration in the annealer identified by the classifier for the subproblem and generating an updated subproblem;
comparing a vector of binary variables of the updated subproblem with a diagonal of a QUBO matrix of the updated subproblem; and
performing a next iteration when the comparison is positive in a simulated annealer.

12. The non-transitory storage medium of claim 11, wherein the original problem comprises a QUBO and the subproblems comprise subQUBOs that are each smaller than the QUBO.

13. The non-transitory storage medium of claim 12, further comprising training the classifier to predict or classify, for a subQUBO, a recommended annealer.

14. The non-transitory storage medium of claim 13, wherein the annealer is one of a simulated annealer, a simulated quantum annealer, and a physical quantum annealer.

15. The non-transitory storage medium of claim 14, further comprising performing an iteration of the subQUBO with the recommended annealer to obtain an updated subQUBO.

16. The non-transitory storage medium of claim 15, further comprising determining a difference between a maximum element in the vector with a minimum value on a diagonal of the subQUBO matrix.

17. The non-transitory storage medium of claim 16, further comprising inputting the updated subQUBO to the classifier when the difference is not positive.

18. The non-transitory storage medium of claim 17, further comprising performing another iteration with the simulated annealer when the difference is positive or performing another iteration with a new recommended annealer output by the classifier.

19. The non-transitory storage medium of claim 11, further comprising performing a predetermined number of iterations based on the comparison or until the subQUBO is minimized.

20. The non-transitory storage medium of claim 11, wherein a QUBO composition after an l^{th} iteration is represented by S^{l}=ΣΣ_{j∈{1 . . . K}\k}xₖ^{T}\hat{Q}ₖⱼxⱼ^{l-1}=x^{T}sₖ^{l}, and wherein the comparison includes a difference between a maximum element on a vector sₖ^{l} and a minimum value on the diagonal of Q_{k,k}.
